(19) United States
(12) Patent Application Publication
(10) Pub. No.: US 2010/0295688 A1
(43) Pub. Date: Nov. 25, 2010

(54) Illumination device and control method thereof

(75) Inventors: Shang-Hsuang Wu, Hsinchu (TW); Ken-Chih Chang, Hsinchu (TW); Chih-Cheng Chou, Hsinchu (TW); Chin-Hao Wu, Hsinchu (TW)

Correspondence Address: BACON & THOMAS, PLLC, 625 SLATERS LANE, FOURTH FLOOR, ALEXANDRIA, VA, 22314-1176, US

(73) Assignee: YOUNG GREEN ENERGY CO., Hsinchu (TW)

(21) Appl. No.: 12/662,634

(22) Filed: Apr. 27, 2010

(30) Foreign Application Priority Data
May 20, 2009 (CN) 200910141088.8

(51) Int. Cl. G08B 17/00; H01J 61/52

(52) U.S. Cl. 340/584; 315/117

(57) ABSTRACT

An illumination device and a control method of the illumination device are provided. The illumination device includes a thermal sensor and a light emitting diode (LED) module. The control method include steps of: enabling the thermal sensor to detect the environment temperature outside the illumination device, and comparing the environment temperature with a threshold value, wherein if the environment temperature is higher than the threshold value, the driven current of the LED module is reduced and the thermal sensor is shut down within a continued period of time.

### CROSS-REFERENCE TO RELATED APPLICATION

This application claims the priority benefit of Taiwan application serial no. 98113521, filed on Apr. 23, 2009.

### BACKGROUND OF THE INVENTION

1. Field of the Invention

The invention generally relates to an illumination device, and more particularly, to an illumination device with light emitting diodes and a control method of the illumination device.

2. Description of Related Art

The recent high intensity light emitting diode (LED) is still expensive, and the LED module of an LED lighting device includes more than one LED. In the LED lighting device, the cost of the LED module is expensive. Some LED modules use a passive heat dissipation mode, for example, a heat dissipation column or a heat dissipation fin. Some LED modules use an active heat dissipation mode, for example, fans or a thermoelectric cooling chip, to keep the LED module at an appropriate working temperature. Moreover, an overheating protection design may avoid the LED module being burned.

Taiwan patent No. 1294372 discloses an overheating protection method for a LED module. The overheating protection method detects and judges whether the temperature of the LED is out of the threshold value. If the temperature is higher than the threshold value, the current illumination mode is switched to another illumination mode to low down the brightness, and the temperature is detected again. On the contrary, if the temperature is lower than the threshold value, the brightness is adjusted to be full brightness.

Taiwan patent No. M325439 discloses a circuit of an LED device capable of adjusting the brightness of the LED device. A LED temperature detecting unit may detect the temperature of the LED via a thermal resistance, and then the LED output control unit determines whether lower the current output of the LED module.

Another overheating protection method for LED module is used as prior art. When the temperature detected by a thermal sensor is over-high, the circuit between the LED module and the electricity source is broken down to terminate the LED module lighting.

Another overheating protection method for LED module is also used as prior art. The LED module driving current is adjusted according the change of the temperature detected by a thermal sensor, so as to adjust the temperature of the LED module.

However the conventional prior arts are not in consideration of the relation between the LED module and the environment temperature. When an overheating protection actuates for the LED module, it comes with some shortages, for example, the LED module may be shut down suddenly that makes the user unable to response in time and thus an accident may happen. Additionally, the brightness of the LED module changes and sparks continuously in a short period, which makes the user uncomfortable.

The temperature may affect the life and the brightness of the LED. If the LED lighting device employs the passive heat dissipation mode, that is, natural convection and heat conducting, the radiator may have a big volume and heavy weight, and thus the radiator becomes a heavy burden for the LED lighting device companies. For designing an LED lighting device, the safety of the user, the heat dissipation of the LED lighting device, the relation between the LED lighting device and the environment temperature may all be considered. The above mentions are important subjects for the LED lighting device companies.

### SUMMARY OF THE INVENTION

The invention provides a control method of an illumination device to protect a light emitting diode module of the illumination device from overheating and to make the brightness of the light source stable.

The invention provides an illumination device to protect a light emitting diode module of the illumination device from overheating and to make the brightness of the light source stable.

An embodiment of the invention provides a control method for an illumination device, and the illumination device includes a thermal sensor and a light emitting diode (LED) module. The control method includes steps of enabling the thermal sensor to detect an environment temperature outside the illumination device, and comparing the environment temperature with a threshold value, wherein a driven current of the LED module is reduced within a continued period of time when the environment temperature is higher than the threshold value, the reduced driven current is used to drive the LED module to emit a light, and the thermal sensor is shut down within the continued period of time

An embodiment of the invention provides an illumination device; the illumination device includes a light emitting diode (LED) module, a thermal sensor, a driver, and a control circuit. The LED module includes at least one LED. The thermal sensor is adapted to detect an environment temperature outside the illumination device. The driver is electrically connected to the light emitting diode module and capable of driving the LED module to emit a light. The control circuit is electrically connected to the thermal sensor and the driver, and the control circuit is adapted to compare the environment temperature detected by the thermal sensor with a threshold value. When the environment temperature is higher than the threshold value, a driven current of the LED module is reduced within a continued period of time and the reduced driven current is used to drive the LED module to emit a light and the thermal sensor is shut down within the continued period of time.

In an embodiment of the invention, the driven current is a pulse width modulated signal and the control circuit reduces the driven current by modulating a working period of the pulse width.

In an embodiment of the invention, the reduced driven current is smaller than or equivalent to 80% of a rated driven current of the LED module.

In an embodiment of the invention, the control method further includes a step of determining a reduction amplitude of the driven current according to a difference between the environment temperature and the threshold value.

In an embodiment of the invention, the continued period of time is more than or equivalent to 9 seconds.

In an embodiment of the invention, the illumination device further includes a temperature display device electrically connected to the control circuit and the temperature display device is adapted to display the environment temperature.

In an embodiment of the invention, the control circuit is capable of re-enabling the thermal sensor after the continued period of time.

In an embodiment of the invention, after re-enabling the thermal sensor, the control circuit is capable of control the driver to drive the light emitting diode module to emit a light with a rated current of the light emitting diode module when the environment temperature is lower than the threshold value.

In an embodiment of the invention, the illumination device further includes a memory and a temperature display device. The memory is electrically connected to the control circuit and adapted to record the environment temperature. The temperature display device is electrically connected to the control circuit and adapted to display the environment temperature recorded by the memory, and the control circuit refreshes the environment temperature recorded by the memory with the environment temperature detected by the thermal sensor when the environment temperature detected by the thermal sensor is higher than the environment temperature recorded by the memory.

In the embodiments of the invention, the control circuit adjusts the driven current of the driver according to the temperature outside the illumination device detected by the thermal sensor, so as to control the brightness of the LED module. Thus an LED overheating protection method is provided, and a stable LED light source is also provided. The stable LED light source illuminates a place and avoiding the dangerous from sparkling or suddenly change of the light source.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a block diagram of an illumination device according to an embodiment of the invention.

FIG. 2 is a flow diagram of a control method according to the embodiment in FIG. 1.

FIG. 3 is a relational diagram between a driven current and time according to the embodiment in FIG. 2.

FIG. 4 is a block diagram of an illumination device according to another embodiment of the invention.

FIG. 5 is a flow diagram of a control method of an illumination device according to another embodiment of the invention.

FIG. 6 is a block diagram of an illumination device according to another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

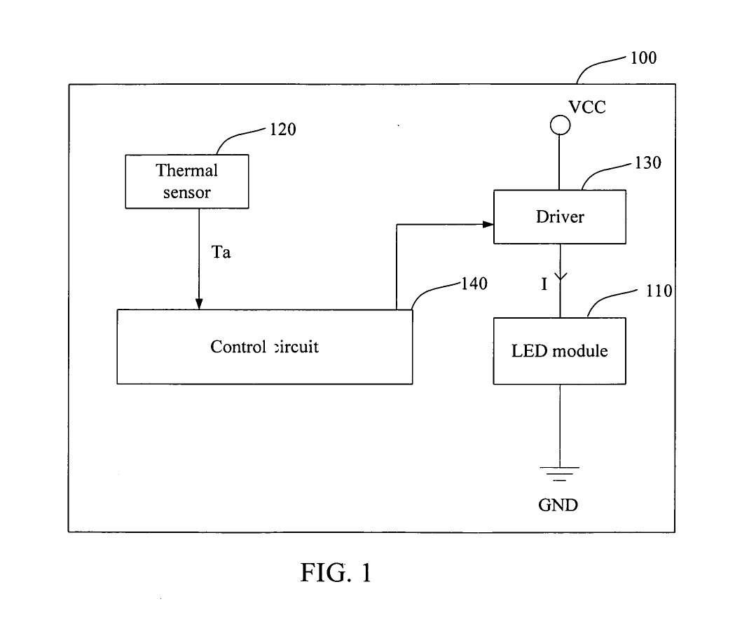

Referring to FIG. 1, the illumination device 100 includes a light emitting diode module (LED module) 110, a thermal sensor 120, a driver 130 and a control circuit 140. The LED module 110 includes at least one LED. One terminal of the LED module 110 is grounded. The thermal sensor 120 is capable of detecting an environment temperature outside the illumination device 100. The driver 130 is electrically connected to a voltage VCC, the LED module 110, and the control circuit 140. The driver 130 drivers the LED module 110 to emit a light.

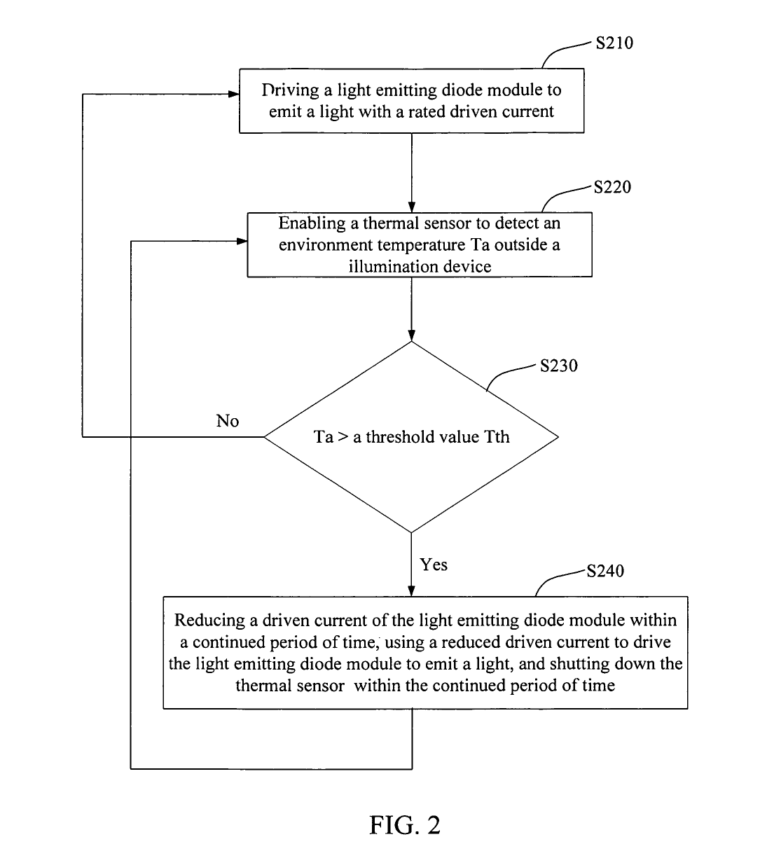

Referring to FIG. 2, the control method includes the following steps. In step S210, the driver 130 drives the LED module 110 with a rated driven current. The rated driven current means that the value of the driven current driving the LED module 110 to emit a light before lowering the driven current down in the step S240. The rated driven current is set by the manufacturer of the LED module 110 according to security standard.

In step S220, the control circuit 140 enables the thermal sensor 120 to detect the environment temperature Ta outside the illumination device 100. The difference between the thermal sensor 120 and a traditional thermal sensor is the temperature detecting area. In Consideration of the temperature of the illumination device 100 and the temperature of the environment outside the illumination device 100, the thermal sensor 120 is capable of detecting the environment temperature Ta outside the illumination device 100, and the traditional thermal sensor detects the temperature inside the illumination device.

In step S230, the control circuit 140 compares the environment temperature Ta detected by the thermal sensor 120 with an upper threshold value Tth of the temperature, when the environment temperature Ta detected by the thermal sensor 120 is higher than the upper threshold value Tth, the step S240 is performed, or back to step S210 and the LED module is drove with the rated driven current.

The upper threshold value Tth of the temperature is set according to the temperature of the illumination device 100 and the environment temperature outside the illumination device 100, or is set by the maintenance worker. For example, when the environment temperature outside the illumination device 100 is −20° C.˜40° C., the heat dissipation mode of the LED module 110 may keep the LED module 110 at a safe working temperature; when the environment temperature outside the illumination device 100 is 40° C.˜80° C., in consideration of the heat dissipation ability of the heat dissipation mode of the LED module 110 for dissipating heat generated by the LED module 110, if the environment temperature is higher than 80° C., the heat dissipation mode of the LED module 110 may not able to keep the LED module 110 at a safe working temperature, and thus, the upper threshold value Tth of the temperature is set at 80° C. The upper threshold value Tth is set according to the heat dissipation ability of the heat dissipation mode of the LED module 110 and the environment, and is not limited to the embodiments above.

In step S240, the environment temperature Ta is higher than the threshold value Tth. A driven current I for the LED module 110 of the driver 130 is reduced by the control circuit 140 within a continued period of time Tcont and the control circuit 140 shuts down the thermal sensor 120 within the continued period of time Tcont, stops detecting the environment temperature Ta outside the illumination device 100, and controls the temperature of the LED module 110. For example, when the threshold value is set at 80° C. and the environment temperature Ta is higher than 80° C., the control circuit 140 lowers down the driven current I. Thus, the lighting brightness of LED module 110 becomes weaker. Within the continued period of time Tcont, one effect on shutting down the thermal sensor 120 is to save electrical energy due not to detect the environment temperature Ta, and another effect is to avoid the LED module 110 continuously sparkling in a short period of time resulting from the environment temperature Ta vibrating around the threshold value Tth.

After the step S240, step S220 is performed to detect the environment temperature Ta.

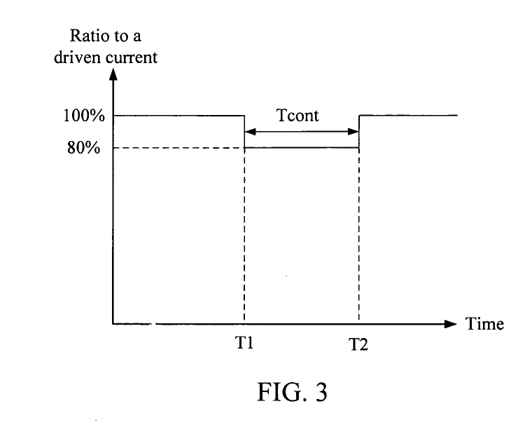

Referring to FIG. 3, the ordinate axis stands for the ratio of the driven current Ito the rated driven current of the LED module 110, and the horizontal axis stands for time. At time T1, the environment temperature Ta is detected and it is higher than the threshold value Tth. So at the time T1, the step S240 is performed to lower the driven current I, and the driven current I is reduced 20% of the rated driven current, so that the reduced driven current I is equivalent to 80% of the rated driven current of the LED module 110. As a result, within the continued period of time Tcont from the time T1 to the time T2, the control circuit 140 drives the LED module 100 with 80% of the rated driven current, and within the continued period of time Tcont, the thermal sensor 120 is shut down and stopped detecting the environment temperature. At the time T2, the control circuit 140 performs step S210 to control the driver 130 to re-drive the LED module 110 with 100% of the rated driven current. The continued period of time Tcont is longer or equivalent to 9 seconds to avoid the light brightness changing and sparkling continuously. The methods of lowering down the driven current are not limit to the above-mentions. For example, in another embodiment of the invention, the control circuit 140 may determine the reduction amplitude of the driven current according to the difference of the environment temperature Ta detected by the thermal sensor 120 and the threshold value Tth. Taking 5° C. as an arithmetic progression, lowering 5% of the rated driven current is for each arithmetic progression. In other words, when the environment temperature Ta is 5° C. higher than the threshold value Tth, the driven current I is reduced as 95% of the rated driven current; when the environment temperature Ta is 10° C. higher than the threshold value Tth, the driven current I is reduced as 90% of the rated driven current. In another embodiment of the invention, the method of lowering down the driven current is that modulating the driven current as X % of the rated driven current when the environment temperature Ta is higher than the threshold value Tth, wherein 40≦X<100. In another embodiment of the invention, the continued period of time Tcont may extend to 20 seconds, 30 seconds or 40 seconds. Within the continued period of time Tcont, since the environment temperature is not detected and the driver current I of the LED module 110 is adjusted, so the brightness of the LED module 110 is stable to avoid the LED module 110 being sparkling.

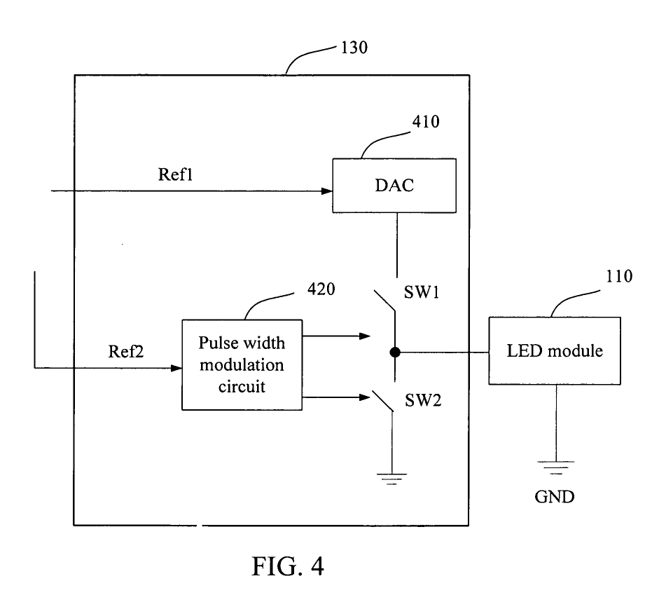

Referring to FIG. 4, the driver 130 is a DC to DC converting circuit, and it could be a buck driver, a boost driver or a buck-boost driver. In the embodiment, the driver 130 includes a digital-to-analog converter (DAC) 410, a pulse width modulation (PWM) circuit 420, a switch SW1 and switch SW2. The switch SW1 and switch SW2 are electrically connected to the LED module 110. The DAC 410 is capable of receiving a control signal Ref1 transmitted from the control circuit 140 to set the wave crest level of the pulse wave output by SW1 and SW2. The control signal Ref1 is adapted to adjust the electrical value of the pulse wave output by SW1 and SW2, so as to adjust the driven current of the LED module 110. Besides, the PWM circuit 420 is capable of receiving a control signal Ref2 transmitted from the control circuit 140 to set the width of the pulse wave output by the PWM circuit 420. The control signal Ref2 is adapted to adjust the width of the pulse wave output by the PWM circuit 420, so as to adjust the driven current of the LED module 110.

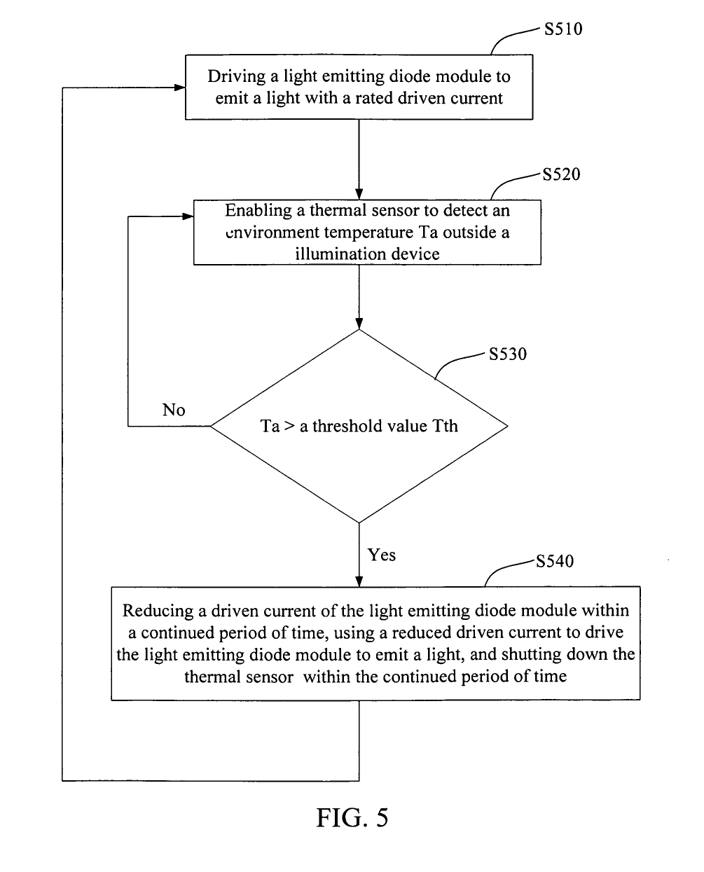

Referring to FIG. 5, in step S530 of the embodiment, when the environment temperature Ta is lower than the threshold value Tth, the step 5520 is performed to re-enable the thermal sensor 120. Otherwise the step S540 is performed to drive the LED module 110 with the reduced driven current within the continued period of time Tcont. After the continued period of time Tcont of the step S540, the step S510 is performed to drive the LED module 110 with the rated driven current. In the following step S520, the control circuit 140 re-enables the thermal sensor 120 to re-detect the environment temperature Ta. The step S530 is performed to re-enable the thermal sensor 120, if the environment temperature Ta is higher than the threshold value Tth, the control circuit 140 may shut down the thermal sensor 120 in the next continued period of time Tcont, and control the driver 130 continuously to drive the LED module 110 with the reduced driven current.

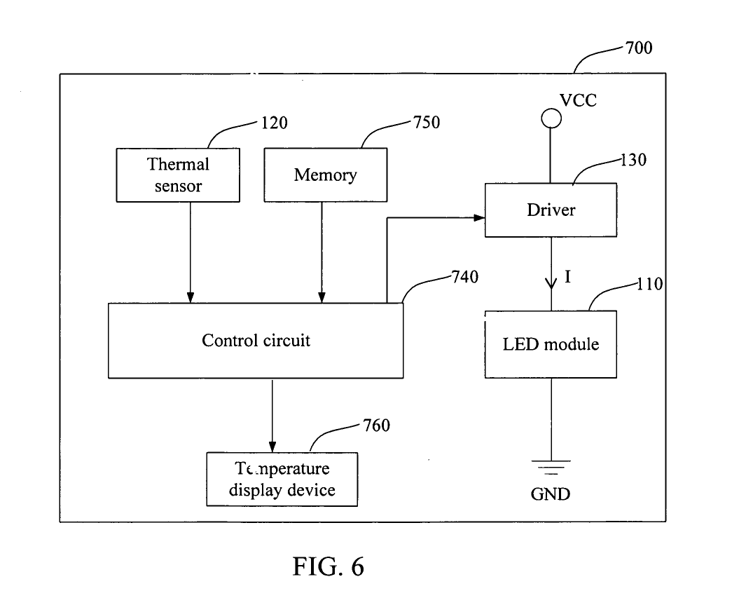

Referring to FIG. 6, the illumination device 700 includes a temperature display device 760. The temperature display device 760 is electrically connected to the control circuit 740 to display the environment temperature Ta. The illumination device 700 further includes a memory 750. The memory 750 is electrically connected to the control circuit 740 to memorize the value of the environment temperature. The temperature display device is capable of displaying the value of the environment temperature memorized by the memory 750 and the environment temperature Ta detected by the thermal sensor 120. When the environment temperature Ta detected by the thermal sensor 120 is higher than the value of the environment temperature memorized by the memory 750, the control circuit 740 is capable of refreshing the value of the environment temperature recorded by the memory 750 with the detected environment temperature Ta.

The way of recording and outputting the environment temperature instantly conveniences the maintenance worker monitoring the temperature of the illumination device. For example, if the illumination device 700 is struck by an unusual temperature and broke down, the maintenance worker may find out how abnormal the temperature is and why according to the environment temperature data memorized by the memory 750. In one embodiment, the temperature display device 760 of the illumination device 700 displays the environment temperature and transfers the temperature information to the remote control center for record or display.

The illumination device of above embodiments may replace the traditional mercury lamp of the street to save more energy. Besides, in the embodiments, the adjusting process avoids continuously lowering down the driven current in a short time, so that the illumination device may not sparkle, and the light source of illumination device of the embodiments may not be shut down suddenly. Comparing with the prior art, the illumination device may not make the user fall in an inconvenience or a dangerous situation, so that the illumination device is helpful for security.

The embodiments of the invention mentioned above detect the environment temperature outside the illumination device to adjust the driven current generated by the driver, so as to control the lighting brightness of the LED module. Thus the illumination device of the embodiments builds up an overheating protection mode and provides stable light source to illuminate the spots using the illumination device, and thus avoid the dangerous from sparkling or suddenly changes of the light source.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A control method for an illumination device, the illumination device comprising a thermal sensor and a light emitting diode module capable of emitting light, the control method comprising steps of:
enabling the thermal sensor to detect an environment temperature outside the illumination device; and
comparing the environment temperature with a threshold value, wherein a driven current of the light emitting diode module is reduced within a continued period of time when the environment temperature is higher than the threshold value, a reduced driven current is used to drive the light emitting diode module to emit a light, and the thermal sensor is shut down within the continued period of time.

2. The control method for the illumination device of claim 1, wherein the reduced driven current is smaller than or equivalent to 80% of a rated driven current of the light emitting diode module.

3. The control method for the illumination device of claim 1, further comprising determining a reduction amplitude of the driven current according to a difference between the environment temperature and the threshold value.

4. The control method for the illumination device of claim 1, wherein the continued period of time is more than or equivalent to 9 seconds.

5. The control method for the illumination device of claim 1, further comprising displaying the environment temperature.

6. The control method for the illumination device of claim 1, further comprising:
recording the environment temperature to a memory; and
displaying the environment temperature recorded by the memory on a temperature display device;
refreshing the environment temperature recorded by the memory with the environment temperature by a control circuit when the environment temperature detected by the thermal sensor is higher than the environment temperature recorded by the memory.

7. The control method for the illumination device of claim 1, further comprising re-enabling the thermal sensor after the continued period of time.

8. The control method for the illumination device of claim 7, further comprising driving the light emitting diode module to emit the light with a rated current of the light emitting diode module when the environment temperature is lower than the threshold value after re-enabling the thermal sensor.

9. The control method for the illumination device of claim 1, further comprising driving the light emitting diode module to emit the light with a rated current of the light emitting diode module when the environment temperature is smaller than the threshold value.

10. The control method for the illumination device of claim 1, wherein the driven current is a pulse width modulated signal and the control circuit reduces the driven current by modulating a working period of the pulse width.

11. An illumination device, comprising:
a light emitting diode module, comprising at least one light emitting diode;
a thermal sensor capable of detecting an environment temperature outside the illumination device;
a driver electrically connected to the light emitting diode module, and capable of driving the light emitting diode module to emit a light; and
a control circuit electrically connected to the thermal sensor and the driver, and capable of comparing the environment temperature detected by the thermal sensor with a threshold value, wherein a driven current of the light emitting diode module is reduced within a continued period of time when the environment temperature is higher than the threshold value and the thermal sensor is stopped detecting the environment temperature within the continued period of time.

12. The illumination device of claim 11, wherein the reduced driven current is smaller than or equivalent to 80% of a rated driven current of the light emitting diode module.

13. The illumination device of claim 11, wherein the driven current is a pulse width modulated signal and the control circuit reduces the driven current by modulating a working period of the pulse width.

14. The illumination device of claim 11, wherein the control circuit is capable of determining a reduction amplitude of the driven current according to a difference between the environment temperature detected by the thermal sensor and the threshold value.

15. The illumination device of claim 11, wherein the continued period of time is more than or equivalent to 9 seconds.

16. The illumination device of claim 11, further comprising a temperature display device electrically connected to the control circuit, and adapted to display the environment temperature.

17. The illumination device of claim 11, further comprising:
a memory electrically connected to the control circuit, and adapted to record the environment temperature; and
a temperature display device electrically connected to the control circuit, and capable of displaying the environment temperature recorded by the memory;
wherein the control circuit refreshes the environment temperature recorded by the memory with the environment temperature detected by the thermal sensor when the environment temperature detected by the thermal sensor is higher than the environment temperature recorded by the memory.

18. The illumination device of claim 11, wherein the control circuit is capable of re-enabling the thermal sensor after the continued period of time.

19. The illumination device of claim 18, wherein the control circuit is capable of controlling the driver to drive the light emitting diode module to emit the light with a rated current of the light emitting diode module when the environment temperature is lower than the threshold value after re-enabling the thermal sensor.

20. The illumination device of claim 11, wherein the control circuit is capable of controlling the driver to drive the light emitting diode module to emit the light with a rated current of the light emitting diode module when the environment temperature is lower than the threshold value.
